(19) United States
(12) Patent Application Publication
(10) Pub. No.: US 2015/0314962 A1
(43) Pub. Date: Nov. 5, 2015

(54) SUB-TERRAIN COOLING AND STORING

(71) Applicant: Charles T. WATTS, Chickamauga, GA (US)

(72) Inventors: Charles T. WATTS, Chickamauga, GA (US); Aubery Claborn NEWSOME, Monteagle, TN (US)

(21) Appl. No.: 14/265,864

(22) Filed: Apr. 30, 2014

(51) Int. Cl. B65G 5/00; F17C 5/06

(52) U.S. Cl. CPC B65G 5/00; F17C 5/06

(57) ABSTRACT

A system includes a plurality of sub-terrain holes, a plurality of cylindrical storage sleeves disposed within the plurality of sub-terrain holes and each having a top end a bottom end, and a pressure release disposed in each of the top end and the bottom end of the plurality of cylindrical storage sleeves to seal the top end and the bottom end.

### BACKGROUND OF THE INVENTION

1. Field of the Invention

The present invention is directed to a sub-terrain or geo-thermal process for storing and cooling natural gases underground. Specifically, the process combines natural gas storage and cooling processes below the earth's surface.

2. Description of the Background Art

Certain conventional natural gas storage systems employ sub-terrain and/or geo-thermal processes for storing natural gases under ground. Specifically, certain conventional systems store natural gas in tanks below the earth's surface.

For example, U.S. Pat. No. 5,333,465 discloses a system for receiving, storing and dispensing compressed natural gas. The system includes an underground facility for storing compressed gas received from a gas compressor, a conduit for conducting compressed gas to the storage facility, and a dispenser for dispensing gas. The underground storage facility includes an elongate casing adapted to be received in a hole in the ground.

The conventional techniques, however, do not combine natural gas storage and cooling processes below the earth's surface using geo-thermal temperatures for sequencing the gas in order to achieve cooling after compression.

### SUMMARY OF THE INVENTION

In view of the foregoing and other exemplary problems, drawbacks, and disadvantages of the conventional methods and structures, an exemplary feature of the present invention is to provide a method and system that combines natural gas storage and cooling processes below the earth's surface using geo-thermal temperatures for sequencing the gas in order to achieve cooling after compression. Specifically, the claimed method/system combines sub-terrain and geo-thermal techniques into one process.

In accordance with a first exemplary, non-limiting aspect of the present invention, a system includes a plurality of sub-terrain holes, a plurality of cylindrical storage sleeves disposed within the plurality of sub-terrain holes, each of the plurality of cylindrical storage sleeves having a top end a bottom end, and a pressure release disposed in each of the top end and the bottom end of the plurality of cylindrical storage sleeves to seal the top end and the bottom end.

In accordance with a second exemplary, non-limiting aspect of the present invention, a method includes supplying hot gas into a storage vessel, said storage vessel being disposed in a sub-terrain hole, compressing the gas and forcing the gas to a bottom of the storage vessel through a pipe extending through the storage vessel, dissipating heat from the hot gas through the storage vessel and into the sub-terrain surface, and forcing cool gas out through a top of the storage vessel.

Accordingly, the present invention is able to store and cool compressed natural gas underground. Specifically, the system and method, according to certain exemplary aspects of the present invention, utilizes the concept of cooling compressed gas or compressed natural gas using sub-terrain or geo-thermal processes and/or storage. Specifically, the present method/system includes compressing gases into the storage vessels, which are inserted into the ground for the purpose of using geo-thermal capacity for cooling or reducing temperature of the compressed gas. Accordingly, the temperature of the gas is reduced and the storage capacity increases. This is because when a temperature of the gas is reduced, then the gas contracts, becomes denser and takes up less space in the storage vessel. Thus, the sub-terrain/geo-thermal cooling system/method of the present invention provides more storage in a smaller space or volume due to the removal of heat generated from compression of the gas.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, do limit the present invention, and wherein:

FIGS. 1A and 1B illustrate a storage vessel according to certain exemplary aspects of the present invention;

FIG. 2 illustrates a system according to the certain exemplary embodiments of the present invention;

FIG. 3 further illustrates the system illustrated in FIG. 2; and

FIG. 4 illustrates an operation of the system in FIGS. 2 and 3.

### DETAILED DESCRIPTION OF EXEMPLARY EMBODIMENTS OF THE PRESENT INVENTION

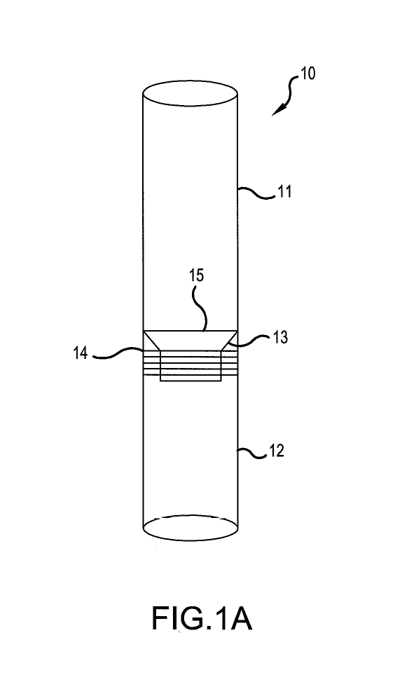

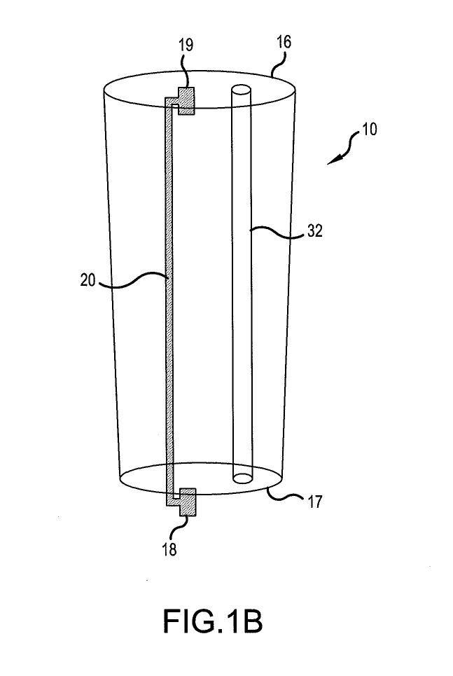

Referring now to the drawings, and more particularly to FIGS. 1A-4, there are shown exemplary embodiments of the method and structures according to the present invention.

Exemplary embodiments of the present invention are directed to a method (and apparatus) for combining natural gas storage and cooling processes below the earth's surface.

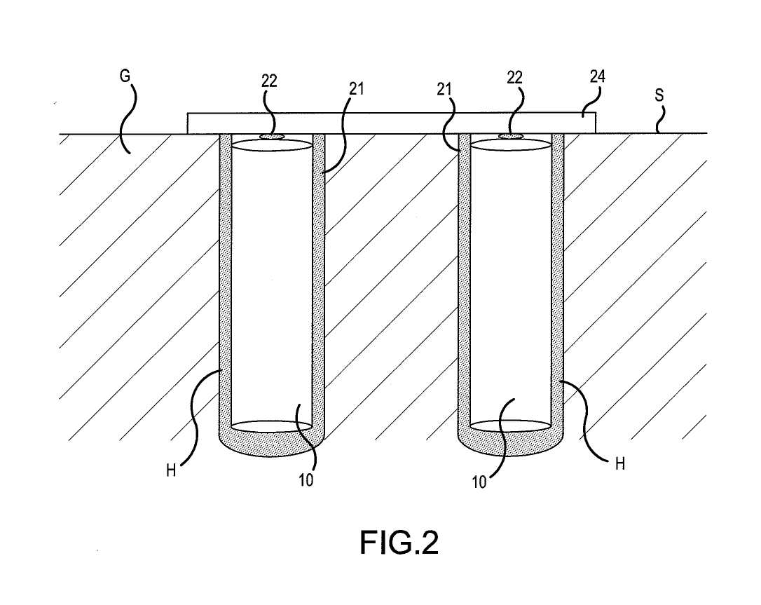

As is illustrated in FIG. 2, the present invention includes drilling one or more holes H into the ground G (i.e., earth's surface layers). The holes H will range in diameter from 2″ to 24″. Preferably, the holes H will have a diameter of 4″, 6″ or 8″. The depths of the holes will vary depending upon the storage needs. For example, the depths of the holes H could range from 10 feet to 10,000 feet. In most situations, the holes H will have a depth of 1,000 to 5,000 feet.

Once the holes H are drilled, the holes are sleeved with metal or other continuous piping to form storage vessels 10. Depending on the depth of the hole H, more than one section of piping may be used to sleeve the hole. FIGS. 1A and 1B illustrate a storage vessel 10 according to certain exemplary aspects of the invention. The storage vessel 10, illustrated in FIGS. 1A and 1B, includes more than one section of piping to form the sleeve. The sections of piping overlap one another at connection points. The sections are joined by beveling and threading the ends.

In the storage vessel 10 illustrated in FIGS. 1A and 1B, the sleeve includes two sleeve sections 11/12. Indeed, as is illustrated in FIG. 1A, one end 13 of the first sleeve section 11 is beveled and threaded such that it is configured to be received in an opposite end 14 of an adjacent sleeve section 12. An interior of the end 14 of the adjacent sleeve section 12 is threaded to threadably engage the end 13 of the first sleeve section 11. The ends of the adjacent sleeve sections are connected by screwing them together. Then, the two adjacent sleeve sections are welded at the connection joint 15 to provide a continuous connection. The wall thickness of a particular storage vessel 10, preferably, is consistent along the entire storage vessel 10 and the individual sleeve segments. The actual wall thickness for the storage vessel 10, however, may vary depending on location, geographic region, environment, etc. where the holes H are drilled.

The completed sleeve/storage vessel has a top end 16 and a bottom end 17, as illustrated in FIG. 1B. Each of the top and bottom ends is sealed and fitted with an emergency pressure release system (EPRS) 18/19. The EPRS includes a release valve connected to a pipe 20 extending along an exterior of the storage vessel 10. The weakest points of the sleeve are at the top bottom. Furthermore, the integrity and safety of the storage vessel 10 depend on the strength of the seals at the top and bottom of the sleeve. The EPRS is configured to protect the integrity and safety of the storage vessel 10 in the event of a rupture at the top or bottom of the sleeve. Specifically, in the event that the sleeve should rupture, the bottom EPRS 18 will allow the gas to release through the pressure valve and escape through the pipe 20 from the bottom 17 of the sleeve to the top 16 of the sleeve or the surface. Additionally, the EPRS is configured to periodically remove any condensation that builds up at the bottom 17 of the storage vessel 10. The EPRS 18/19 is configured to prevent the storage vessel 10 from breaking lose from its casing (detailed below) as a result of pressure release.

Referring again to FIG. 2, the storage vessel 10 is cased into the holes H. That is, a casing material 21 is applied between the outer edges of the storage vessel 10 and the walls of the hole H drilled into the ground G. For example, the casing material 21 includes a slurry material. For example, the casing material may include high-pressure steel or aluminum, which may be used with high-carbon composite wrapping. The casing material 21 anchors the storage vessel 10 to the walls of the hole H and prevents rusting or other deterioration of the storage vessel 10.

The system also includes a pad 24 (e.g., a concrete pad or pad made of other paving material) disposed at the surface S of the ground G and covering the storage vessels 10. Preferably, the pad 24 has a depth of no less than 4″. A flange, safety ring or other attachment 22 is disposed at a top surface of the storage vessel 10 below the pad 24 to anchor the storage vessel 10 to the pad 24.

The system includes at least one hole H and at least one storage vessel 10. The system, however, may include any number of holes H and storage vessels 10 depending on capacity requirements.

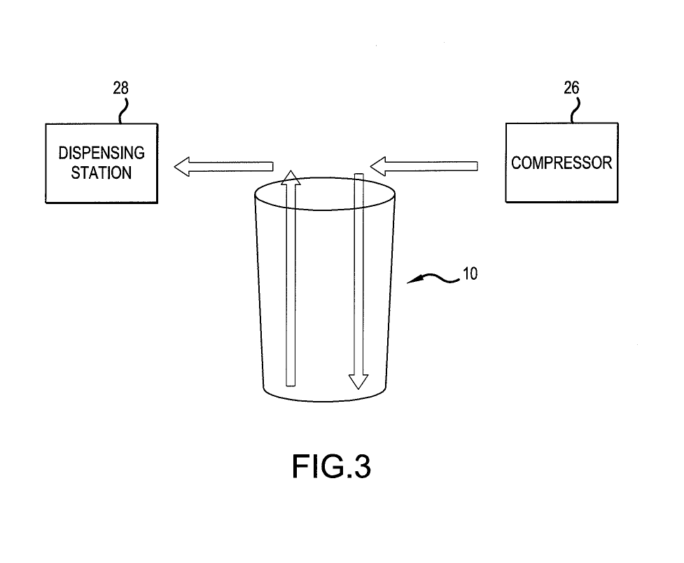

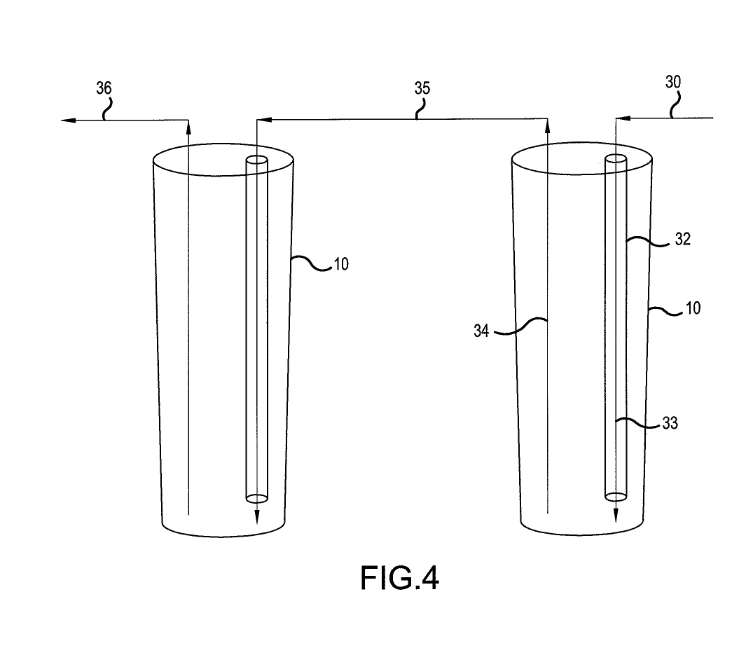

FIGS. 3 and 4 further illustrate the structure and operation of the present system and method. The system and method, according to certain exemplary aspects of the present invention, utilizes the concept of cooling compressed gas or compressed natural gas using sub-terrain or geo-thermal processes and/or storage. Specifically, the present method/system includes compressing gases into the storage vessels 10, which are inserted into the ground G for the purpose of using geo-thermal capacity for cooling or reducing temperature of the compressed gas. Accordingly, the temperature of the gas is reduced and the storage capacity increases. This is because when a temperature of the gas is reduced, then the gas contracts, becomes more dense and takes up less space in the storage vessel 10. Thus, the sub-terrain/geo-thermal cooling system/method of the present invention provides more storage in a smaller space or volume due to the removal of heat generated from compression of the gas.

As illustrated in FIG. 3, the system includes one or more storage vessels 10 stored underground. Gas is supplied to the storage vessel 10 from a compressor 26 and then output from the storage vessel 10 to a dispensing station 28. FIG. 4 illustrates, in detail, the operation of the system and storage vessels 10. Gas/natural gas is compressed into the storage vessels (arrow 30) from the top 16 of the storage vessel 10 and forced to the bottom 17 of the storage vessel 10 through a smaller pipe 32 that runs down the inside of the storage vessel 10. That is, the hot gas from the compressor 26 is forced to the bottom 17 of the storage vessel 10. As the gas is forced down the smaller pipe (arrow 33) the cooling of the gas begins. Once the gas is released at the bottom of the smaller pipe 32, then the hot gas rises. The cooler gas remains at or near the bottom 17 of the storage vessel 10. The cool gas blends with the hot gas while the sub-terrain/geo-thermal process continues to dissipate heat from the gas into the ground G (i.e., earth's crust) or surface S. The cool gas is then forced out through the top of the storage vessel 10 (arrow 34). If the system includes multiple storage vessels 10, then the gas is forced through the same process in adjacent storage vessels 10, which are connected in sequence, without further compression (arrow 35). The process is repeated until a desired temperature is achieved. Once the gas is passed through all of the connected storage vessels 10, the cooled gas is outlet to the dispensing unit 28 (arrow 36).

It is noted that while the invention as described above is directed to the concept of cooling compressed gas or compressed natural gas using sub-terrain or geo-thermal processes and/or storage, the method/system of the invention may generally be directed to any temperature change (i.e., temperature reduction or temperature increase). That is, during the underground compression and storage process, the gas may be warmed instead of cooled. Specifically, the steady subterranean temperature may warm or cool the gas based on, for example, the pressure of the gas supplied to the storage vessels 10.

According to an exemplary aspect of the present system, the gas is compressed at pressures up to 10,000 psi. The source of gas can include, for example, mobile fuel transports, a connection to a natural gas pipeline, a pipeline transport, on-site drilling or other production/processing facilities. Additionally, the gas may be supplied from, for example, oil production, coal production, abandoned oil wells, abandoned coal mines, fracking, horizontal drilling, vertical drilling, land-fills, digestion, anaerobic digestion, chemical reactions, other production resulting from injection into the earth's layers, or any other process or production that recovers naturally occurring gas or gases or synthetically created or produced gas.

Regarding the compressor 26, the compression method may include any process or production of compression that is the result of forcing a gas into a confined space. The rate of compression may vary. The compressors or compression equipment will be fitted or built with digital and electronic safety devices and drives or other automation that will start up and shut off the compression process or processes at or below pressures of 10,000 psi or other assigned pressures. The compression will may be sequenced or staged, but not limited to direct or multi-sequence or multi-staged compression.

The sub-terrain/geo-thermal cooling and storage system/method of the present invention, described above, may be applied to production, delivery, and dispensing of gas/natural gas. In production, wells may be established or built on-site at production locations for the purpose of cooling and storing gas produced from oil production, coal production, abandoned oil wells, abandoned coal mines, fracking, horizontal drilling, vertical drilling, land-fills, digestion, anaerobic digestion, chemical reactions, other production resulting from injection into the earth's layers, or any other process or production that recovers naturally occurring gas or gases or synthetically created or produced gas, gases, or other natural occurring resources. Furthermore, the method and system of the present invention may be applied in order to achieve mass or bulk compressed natural gas (CNG) motor fuel or natural gas or methane for fueling individual vehicles, heavy or light-weight equipment, locomotives, boats or tug boats, barges, or any other type of transport of freight or merchandise.

The storage of CNG motor fuel or natural gas using sub-terrain storage/geo-thermal storage is not only applicable, but also necessary to achieve mass or bulk transport or delivery of CNG motor fuel or natural gas or gases. Delivering CNG motor fuel or natural gas or gases for “fast-fill” and dispensing for individual vehicles or other transportation fleets will be achieved because of the total storage and cooling process capabilities and applications of the present system/method. Delivery under these criteria will be achieved by maintaining prime temperature, storage, and fast-fill dispensing conditions. Prime delivery conditions include maintaining a pressure of not less than 3,600 psi under a constant temperature of not more than 70 degrees Fahrenheit within mobile transport vessels or units.

With the present system, fast-fill dispensing can occur at perfect conditions. That is, whether filling directly from a storage well or from a mobile fuel mill or mobile fuel pod, that filling will occur and remain at less than 100 degrees Fahrenheit. Additionally, CNG motor fuel tanks will be filled up to 4,500 psi pressure so that when the ambient temperature reaches 100 degrees Fahrenheit on a complete fill up, the result will be a full tank of CNG motor fuel after the temperature decreases by as much as 20 degrees and the pressure reduces back to 3,600 psi. Fast-fill dispensing is possible with these techniques, processes, and concepts because the compression occurs before storage and the heat is removed. That is, from on-site underground storage, the fast-fill process is rapid and practice because the temperature is at or near 56 degrees Fahrenheit and the pressure is at or near 10,000 psi. Accordingly, a CNG motor fuel tank may be filled from an equalization process without further compression or heat.

While the invention has been described in terms of several exemplary embodiments, those skilled in the art will recognize that the invention can be practiced with modification within the spirit and scope of the appended claims. Such variations are not to be regarded as a departure from the spirit and scope of the invention, and all such modifications as would be obvious to one skilled in the art are to be included within the scope of the following claims.

Further, it is noted that, Applicant's intent is to encompass equivalents of all claim elements, even if amended later during prosecution.

What is claimed is:

1. A system, comprising:
a plurality of sub-terrain holes;
a plurality of cylindrical storage sleeves disposed within the plurality of sub-terrain holes, each of the plurality of cylindrical storage sleeves having a top end a bottom end; and
a pressure release disposed in each of the top end and the bottom end of the plurality of cylindrical storage sleeves to seal the top end and the bottom end.

2. The system according to claim 1, wherein each of the plurality of cylindrical storage sleeves comprises a plurality of sleeve sections, wherein ends of the sleeves sections are beveled and threaded such that adjacent sleeve sections are screwed together to form said plurality of cylindrical storage sleeves.

3. The system according to claim 1, further comprising a pad disposed above and covering the plurality of cylindrical storage sleeves.

4. The system according to claim 1, further comprising a casing material disposed between an exterior surface of the plurality of cylindrical storage sleeves and a wall of the plurality of sub-terrain holes.

5. The system according to claim 1, further comprising a pipe disposed within and extending from the top end to the bottom end of each of the plurality of cylindrical storage sleeves.

6. The system according to claim 1, wherein the pressure release comprises a release valve.

7. The system according to claim 1, further comprising a pipe attached to the pressure release and extending along an exterior of the storage sleeve.

8. The system according to claim 1, further comprising a compressor configured to supply compressed gas to the plurality of cylindrical storage sleeves.

9. The system according to claim 1, wherein the plurality of cylindrical storage sleeves are connected in sequence.

10. The system according to claim 1, further comprising a gas dispenser configured to receive cooled gas output from the plurality of cylindrical storage sleeves.

11. A method, comprising:
supplying hot gas into a storage vessel, said storage vessel being disposed in a sub-terrain hole;
compressing the gas and forcing the gas to a bottom of the storage vessel through a pipe extending through the storage vessel;
dissipating heat from the hot gas through the storage vessel and into the sub-terrain surface; and
forcing cool gas out through a top of the storage vessel.
